(19) United States
(12) Patent Application Publication
(10) Pub. No.: US 2016/0266737 A1
(43) Pub. Date: Sep. 15, 2016

(54) CALENDAR-BASED SOCIAL NETWORK ENGAGEMENT

(71) Applicant: International Business Machines Corporation, Armonk, NY (US)

(72) Inventors: Michael Bender, Rye Brook, NY (US); David E. Nachman, Morristown, NJ (US); Michael P. Shute, Niantic, CT (US)

(21) Appl. No.: 14/657,166

(22) Filed: Mar. 13, 2015

(51) Int. Cl. G06F 3/0482; H04L 29/08; G06F 17/30

(52) U.S. Cl. CPC G06F 3/0482; G06F 17/30528; H04L 67/306

(57) ABSTRACT

A method for engaging with social media based on calendar content includes receiving profile information, scanning user calendars for a calendar entry of interest, analyzing content from the calendar entry of interest, generating a list of social network profiles corresponding to the content from the calendar entry of interest, and prompting the user to select one or more social network profiles to follow from the generated list of social network profiles. The method may also include prompting the user to select dates to follow and stop following each social network profile from the list of social network profiles. The received profile information may correspond to any of permissions to access calendars, types of social network content to be ignored, or information regarding a normal usage pattern. A computer system and computer program product corresponding to the method are also disclosed herein.

### BACKGROUND OF THE INVENTION

The present invention relates generally to the field of social networking, and more specifically to engaging and disengaging with social networks based on calendar content.

Many social networking platforms offer users the ability to subscribe to certain profiles so that content related to those profiles will be more readily available to them. Some of these social networking platforms may suggest profiles to a user based on profiles they have already subscribed to. However, preferences may change as to which types of profiles a user may want to follow.

### SUMMARY

As disclosed herein, a method for engaging with social media based on calendar content includes receiving profile information, scanning user calendars for a calendar entry of interest, analyzing content from the calendar entry of interest, generating a list of social network profiles corresponding to the content from the calendar entry of interest, and prompting the user to select one or more social network profiles to follow from the list of social network profiles. The method may also include prompting the user to select dates to start following and stop following each selected social network profile from the list of social network profiles. The received profile information may correspond to any of permissions to access calendars, types of social network content to be ignored, or information regarding a normal usage pattern. A computer system and computer program product corresponding to the method are also disclosed herein.

### BRIEF DESCRIPTION OF THE DRAWINGS

FIG. 1 is a functional block diagram depicting a computing environment in accordance with an embodiment of the present invention;

FIG. 2A is a flowchart depicting a social network engagement method in accordance with one embodiment of the present invention;

FIG. 2B depicts an example of profile information corresponding to the social network engagement method in accordance with one embodiment of the present invention;

FIG. 2C depicts an example of an interface that allows a user to select social network pages to follow in accordance with one embodiment of the present invention;

FIG. 3 is a flowchart depicting a calendar entry analysis method in accordance with one embodiment of the present invention; and

FIG. 4 depicts a block diagram of components of the server computer executing the program name, in accordance with an embodiment of the present invention.

### DETAILED DESCRIPTION

While some social networking platforms do currently suggest social network profiles, many of these suggestions occur based strictly on profiles a user is already following. For example, if a user follows profiles corresponding to a specific genre of music, the social networking platform may suggest profiles of other bands that correspond to the same genre to the user. However, these existing suggestion techniques do not account for a user's potential desire to view social networking content corresponding to his/her schedule. The method disclosed herein offers social network engagement based on a user's schedule as indicated by a user's calendar(s).

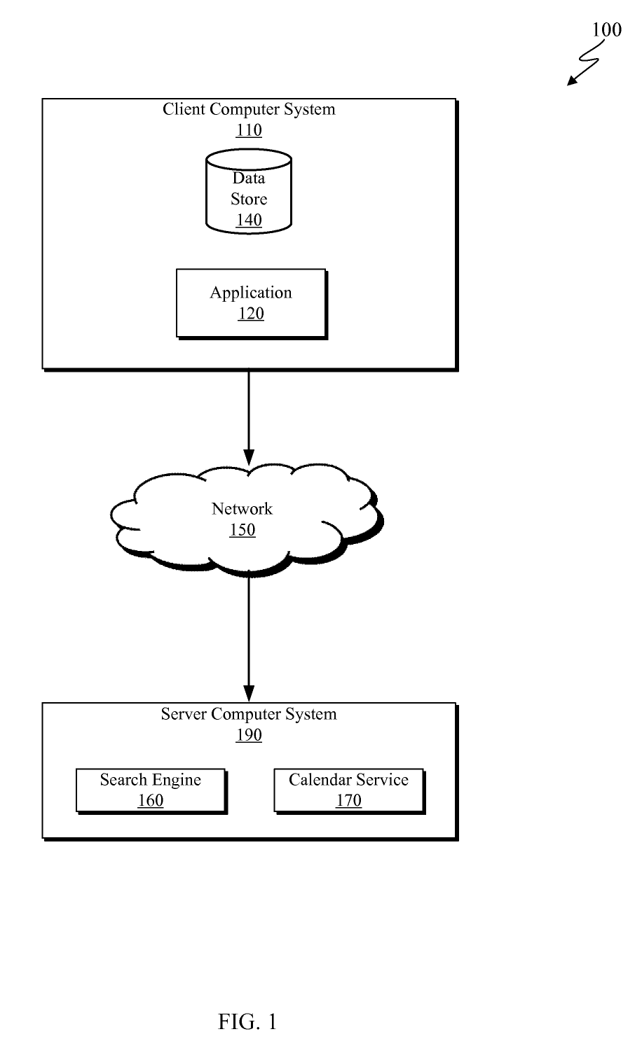

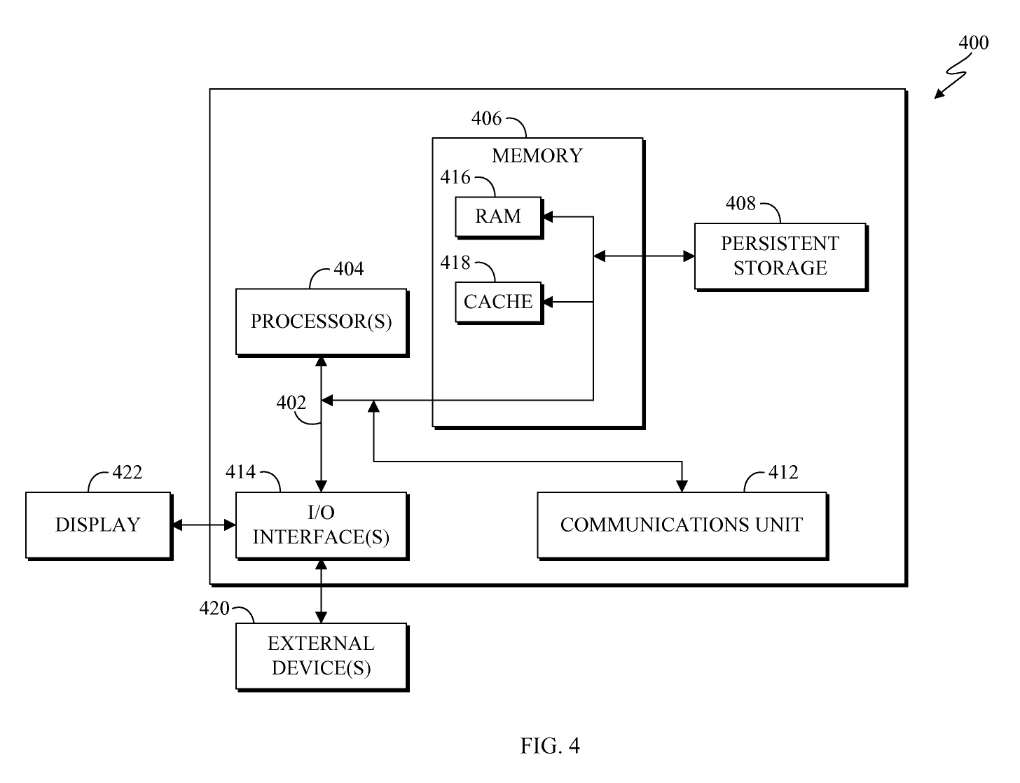

FIG. 1 is a functional block diagram depicting a computing environment 100 in accordance with an embodiment of the present invention. Computing environment 100 includes client computer system 110 and server computer system 190, which can be desktop computers, laptop computers, specialized computer servers, or any other computer systems known in the art. In some embodiments, client computer system 110 and server computer system 190 represent computer systems utilizing clustered computers and components to act as a single pool of seamless resources when accessed through network 150. In general, client computer system 110 and server computer system 190 are representative of any electronic devices, or combination of electronic devices, capable of executing machine-readable program instructions, as described in greater detail with regard to FIG. 4.

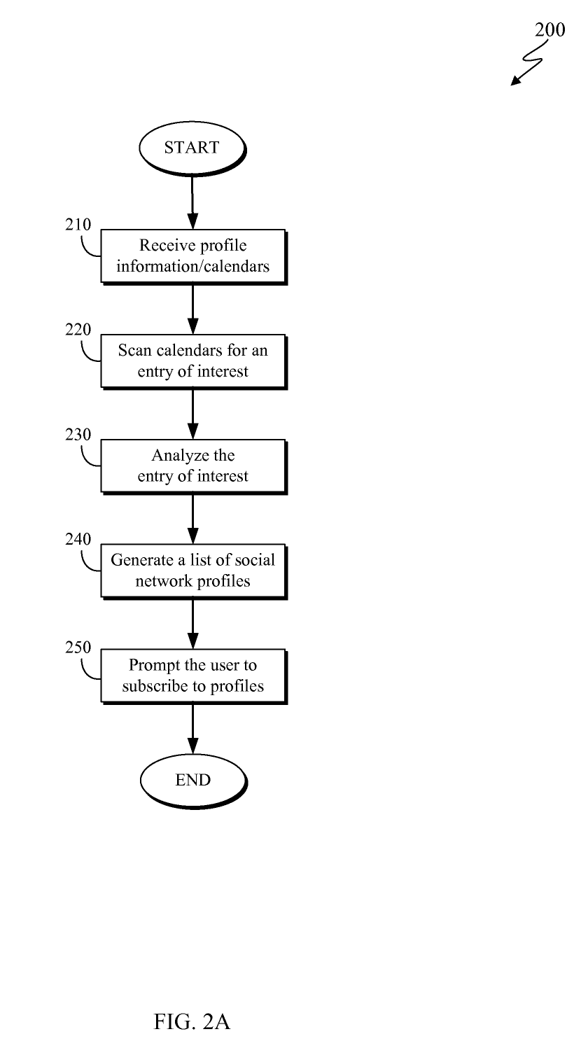

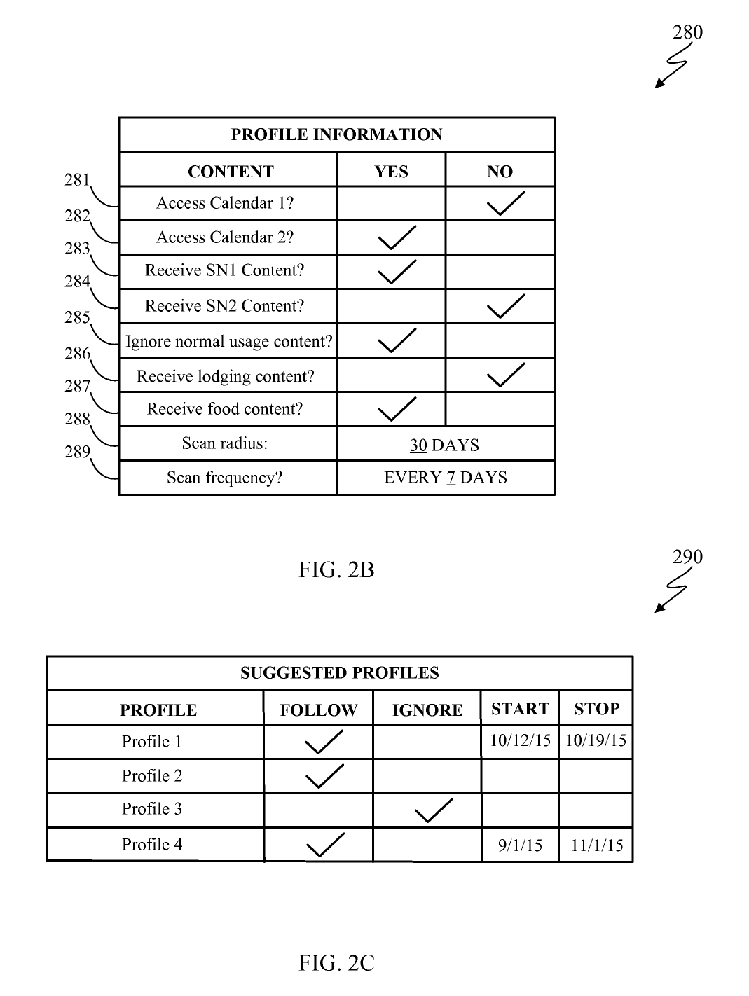

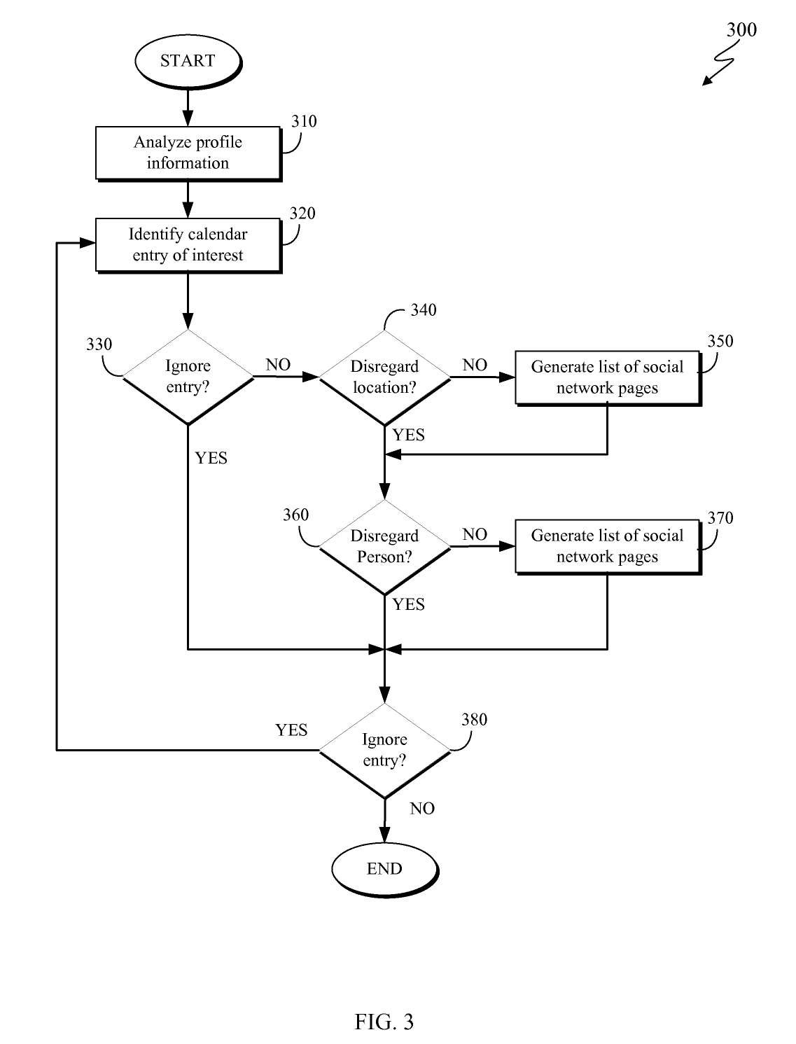

Client computer system 110 may include application 120 and data store 140. Application 120 may be configured to scan user calendars and conduct a search based on the content from the calendars. Scanning user calendars may include accessing calendars stored on data store 140 or calendars available through calendar service 170 via network 150. A more detailed description of calendar analysis as executed by one embodiment of the application 120 is included with respect to FIG. 2A and FIG. 3. Application 120 enables client computer system 110 to access search engine 160. Application 120 communicates with server computer system 190 via network 150 (e.g. using TCP/IP) to enter one or more search queries comprising query terms (e.g., pertaining to a particular subject area that is related to the scanned calendar content). For example, application 120 can be implemented using a browser and web application that transmits search queries to, and receives results from, server computer system 110.

Data store 140 may store user calendars or profile information corresponding to social network engagement method 200 (as depicted in FIG. 2A). Data store 140 may be any non-volatile storage media known in the art. For example, data store 140 can be implemented with a tape library, optical library, one or more independent hard disk drives, or multiple hard disk drives in a redundant array of independent disks (RAID). Similarly, data on data store 140 may conform to any suitable storage architecture known in the art, such as a file, a relational database, an object-oriented database, and/or one or more tables.

The depicted server computer system 190 includes search engine 160 and calendar service 170. Search engine 160 is capable of executing a search query received from application 120 and returning results to application 120 via network 150. Calendar service 170 may be a web-based calendar service available to application 120 via network 150.

Network 150 can be, for example, a local area network (LAN), a wide area network (WAN) such as the Internet, or a combination of the two, and include wired, wireless, or fiber optic connections. In general, network 150 can be any combination of connections and protocols that will support communications between server computer system 190 and client computer system 110 in accordance with an embodiment of the present invention.

FIG. 2A depicts a social network engagement method 200. As depicted, the method 200 includes receiving (210) profile information, scanning (220) user calendars for a calendar entry of interest, analyzing (230) content from the calendar entry of interest, generating (240) a list of social network profiles corresponding to the content from the calendar entry of interest, and prompting (250) the user to select one or more social network profiles to follow from the list of social network profiles. The social network engagement method 200 enables a user to follow social network content relevant to his/her schedule.

Receiving (210) profile information may include receiving information within a profile that has been manipulated by the user. Information within the profile may include permissions to access different calendars, how frequently the method is executed, preferred social network profile types, and if profiles related to specific people or places should be ignored. FIG. 2B depicts one example of profile information 280 as indicated by a user.

Referring back to FIG. 2A, scanning (220) user calendars for a calendar entry of interest may include accessing calendar data to isolate a calendar entry to be analyzed. In one embodiment, scanning (220) may begin scanning entries at the time the method is initiated and identify the calendar entry that occurs next. In one embodiment, a calendar entry of interest may be identified as an accepted calendar entry. Scanning (220) user calendars for a calendar entry of interest may also include identifying people or locations associated with the calendar entry. People associated with a calendar entry may be identified based on an email address linking them to the calendar entry. Scanning (220) user calendars for a calendar entry of interest may further include scanning entries for the next month, or the next week, or for a variable amount of time that can be set by the user and indicated by the profile information.

Analyzing (230) content from the calendar entry may include identifying content linked to the calendar entry and determining if, based on the profile information, a list of social network profiles corresponding to the content should be generated. FIG. 3 depicts a more detailed description of one embodiment of the analysis step 230.

Generating (240) a list of social network profiles corresponding to the content from the calendar entry of interest may include retrieving social network profiles related to the content in the calendar entry of interest. For example, if a calendar entry indicates that a user will be attending a meeting in a hotel in a particular city in the next week, then social network profiles corresponding to businesses and restaurants in the surrounding area may be retrieved. In that same example, if the profile information indicates that a user does not want to retrieve suggestions for specific content, such as fast food, then profiles corresponding to that particular content will not be retrieved. In one embodiment, generating (240) a list of social network profiles further includes adding the generated list of social network profiles to a larger list of social network profiles that will be presented to the user once the scan is complete.

Prompting (250) the user to follow the social network profiles from the list of social network profiles may include presenting the generated list of social network profiles to the user via a graphical user interface (GUI). The user may then indicate whether or not to follow each of the social network profiles. In one embodiment, the user may also be prompted via the GUI to indicate a start date and a stop date for his/her subscription to each social network profile. FIG. 2C depicts a GUI in accordance with one embodiment of the present invention.

FIG. 2B depicts profile information 280. Profile information 280 indicates, in sections 281-282, that two calendars were detected, and that the user is allowing the application to access calendar 2 but not calendar 1. Sections 283-284 correspond to whether or not information will be suggested from specific social networks (named SN1 and SN2 in this example). The user has indicated that content from SN2 is to be ignored. These two configurable features allow a user to feasibly isolate only calendars and networks related to his/her occupation, such that he/she will only receive suggestions that are related to his/her professional life. Section 285 indicates that the user opted to ignore normal usage content. Normal usage patterns correspond to regularly occurring calendar events that have been. Section 286 indicates that the user opted not to receive social network profiles corresponding to content regarding lodging accommodations (hotels, motels, etc.), but has opted to receive social network profiles corresponding to content regarding food in section 287 (restaurants, fast food, bars, etc.). Section 288 allows the user to select a scan radius, which indicates how far into the future the method should look for calendar events to be analyzed. In some embodiments, the scan radius may also indicate how far in the past events should be scanned, such that relevant events from the past can be caught as well. Section 289 allows the user to indicate how frequently the method is executed and suggests pages; in this example, the user has indicated that the scans are to occur every seven days.

FIG. 2C depicts an example of an interface 290 through which a user may be prompted to follow the list of generated social network profiles. In this example, the list yielded four profiles (Profile 1, Profile 2, Profile 3, and Profile 4), and the user has opted to ignore profile 3. According to the user's input, the user will be subscribed to Profile 1 beginning on October 12, and will be unsubscribed from Profile 1 a week later on October 19. Similarly, the user will begin following Profile 4 on September 1, and will stop following Profile 4 on November 1. Indicating start and stop dates such as these enables the user to only see content pertaining to a certain city for the duration of his/her stay there. Lastly, the user has opted to follow Profile 2, but has not indicated any stop or start dates. In this case, the user will be subscribed to Profile 2 immediately, with no scheduled date to stop following Profile 2.

FIG. 3 is a flowchart depicting operational steps of a calendar entry analysis method 300 in accordance with one embodiment of the present invention. As depicted, the calendar entry analysis method 300 includes analyzing (310) profile information, scanning (320) calendars for an entry of interest, determining (330) whether or not the entry should be ignored based on the profile information, determining (340) if the calendar entry corresponds to a unique location, generating (350) a list of social network profiles corresponding to the unique location, determining (360) if the calendar entry corresponds to a unique person, generating (370) a list of social network profiles corresponding to the unique person, and determining (380) if there are more calendar entries to be analyzed. The calendar entry analysis method 300 may be used to create a list of social network profiles that may be of interest to a user based on the user's calendar entries for a configurable period of time.

Analyzing (310) profile information may include determining what parameters the profile indicates for scanning the user's calendars. For example, the profile information may indicate that each iteration of the calendar entry analysis method 300 should process calendar entries for the next two weeks, which will indicate a stopping point for the scanning step 320. Additionally, the profile information may indicate that entries related to a normal usage pattern is to be ignored. Further, the profile information may also indicate if social network profiles related to a certain subject matter (fast food, etc.) are to be excluded from the generated list of social network profiles. Information of this sort will impact the determination steps later in the method. Analyzing (310) profile information may further include compiling a list of types of ignorable content that will be consulted by the determination steps that follow.

Identifying (320) a calendar entry of interest may include selecting one of the calendar entries scanned in operational step 220 (FIG. 2A) to be analyzed by the calendar entry analysis method. In the depicted embodiment, entries are analyzed one at a time, so the identification occurs multiple times until all the entries within a given timeframe have been analyzed by the calendar entry analysis method 300.

Determining (330) whether or not the entry should be ignored based on the profile information may include ignoring the calendar entry if it corresponds to content that the profile information indicates is not of interest. In one embodiment, content to be ignored includes content that corresponds to a normal usage pattern. In one embodiment, determining (330) whether or not the entry should be ignored includes consulting the compiled list of ignorable content to see if the calendar entry of interest corresponds to content on the list, and ignoring it if it does. If the entry is to be ignored (yes branch), the method continues to determining (380) if there are more entries to be processed. If the entry is not to be ignored (no branch), then the method continues to determining (340) whether or not to disregard the location corresponding to the calendar entry of interest.

Determining (340) whether or not to disregard the location associated with the calendar entry of interest may include determining if the location corresponds to an ignorable location based on the profile information. A calendar entry may have ignorable content even if it has been determined the entry on a whole is not ignorable; determining (340) whether or not to disregard the location includes determining if the location is the “interesting” part of the calendar entry or not. If the location is to be disregarded (yes branch), then the method continues to determining (360) whether or not to disregard the person(s) corresponding to the calendar entry of interest. If the location is not to be disregarded (no branch), then the method continues to generating (350) a list of social network profiles.

Generating (350) a list of social network profiles corresponding to the location may include conducting a search on social networking platforms for content corresponding to the location indicated by the calendar entry of interest. For example, if a calendar entry indicates the user will be in Raleigh for a meeting, then social network profiles corresponding to services of interest in Raleigh (hotels, restaurants, etc.) will be added to the list. In one embodiment, the list may conduct a search on only those social networking platforms indicated in the profile information. Generating (350) a list of social network profiles may further include annexing the profiles found by the search to a master list of social network profiles that is presented to the user after all calendar entries have been analyzed.

Determining (360) whether or not to disregard person(s) associated with the calendar entry is nearly the same process as determining (340) whether or not to disregard the location associated with the calendar entry of interest, except the subject in this case is the person(s) associated with the entry as opposed to the location. In one embodiment, the person(s) associated with the calendar entry are identified based on an email address (or email addresses) associated with the calendar entry. If the person(s) is to be disregarded (yes branch), then the method continues to determining (380) whether or not there are more calendar entries to be analyzed. If the location is not to be disregarded (no branch), then the method continues to generating (370) a list of social network profiles.

Generating (370) a list of social network profiles corresponding to the unique person may include conducting a search on social networking platforms for content corresponding to the person(s) indicated by the calendar entry of interest. For example, if a calendar entry indicates the user has a meeting with John Smith, then social network profiles corresponding to John Smith will be added to the list. In one embodiment, the search for social network profiles corresponding to John Smith identifies social network profiles linked to the email address that linked John Smith to the calendar entry of interest. In some embodiments, the list may conduct a search on only those social networking platforms indicated in the profile information. Generating (370) a list of social network profiles may further include annexing the profiles found by the search to a master list of social network profiles that is presented to the user after all calendar entries have been analyzed.

Determining (380) if there are more calendar entries to be analyzed may include checking to see if all calendar entries within the timeframe indicated by the profile information have been analyzed. If there are more calendar entries remaining (yes branch), the method returns to identifying (320) a calendar entry of interest. If there are no more calendar entries remaining (no branch), the method concludes.

FIG. 4 depicts a block diagram of components of computer 400 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

As depicted, the computer 400 includes communications fabric 402, which provides communications between computer processor(s) 404, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media.

One or more programs may be stored in persistent storage 408 for access and/or execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links.

I/O interface(s) 414 allows for input and output of data with other devices that may be connected to computer 400. For example, I/O interface 414 may provide a connection to external devices 420 such as a keyboard, keypad, a touch screen, and/or some other suitable input device. External devices 420 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 408 via I/O interface(s) 414. I/O interface(s) 414 also connect to a display 422.

Display 422 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method, the method comprising:
receiving profile information corresponding to user calendars and user preferences;
scanning one or more user calendars for a calendar entry of interest;
analyzing the calendar entry of interest to identify a location or person of interest corresponding to the calendar entry;
generating a list of social network profiles related to the location or person of interest corresponding to the calendar entry; and
prompting the user to select one or more social network profiles to follow from the generated list of social network profiles.

2. The method of claim 1, wherein the profile information includes permissions to access a plurality of calendars from multiple calendar services.

3. The method of claim 1, wherein the profile information corresponds to user preferences regarding when to scan the user calendars.

4. The method of claim 1, wherein the profile information corresponds to user preferences regarding what type(s) of social network profiles to suggest and what type(s) of social network profiles to ignore.

5. The method of claim 1, wherein prompting the user to select one or more social network profiles to follow from the generated list of social network profiles further comprises prompting the user to select dates to begin following to and to stop following the social network profiles.

6. The method of claim 1, wherein the calendar entry of interest corresponds to a calendar entry that has been accepted by the user.

7. The method of claim 1, wherein receiving profile information further comprises receiving information corresponding to a normal usage pattern.

8. The method of claim 7, wherein the profile information indicates whether or not to ignore entries corresponding to the normal usage pattern.

9. A computer program product for engaging with social networks, the computer program product comprising:
one or more computer readable storage media and program instructions stored on the one or more computer readable storage media, the program instructions comprising instructions to:
receive profile information corresponding to user calendars and user preferences;
scan user calendars for a calendar entry of interest;
analyze the calendar entry of interest to identify a location or person of interest corresponding to the calendar entry;
generate a list of social network profiles corresponding to the location or person of interest corresponding to the calendar entry; and
prompt the user to select one or more social network profiles to follow from the generated list of social network profiles.

10. The computer program product of claim 9, wherein the profile information corresponds to user preferences regarding what type(s) of social network profiles to suggest and what type(s) of social network profiles to ignore.

11. The computer program product of claim 9, wherein the profile information corresponds to user preferences regarding when to scan the user calendars.

12. The computer program product of claim 9, wherein instructions to prompt the user to select one or more social network profiles to follow from the generated list of social network profiles further comprise instructions to prompt the user to select dates to begin following and to stop following the social network profiles.

13. The computer program product of claim 9, wherein instructions to receive profile information further comprise instructions to receive information corresponding to a normal usage pattern.

14. The computer program product of claim 13, wherein the profile information indicates whether or not to ignore entries corresponding to the normal usage pattern.

15. A computer system, the computer system comprising:
one or more computer processors;
one or more computer-readable storage media;
program instructions stored on the computer-readable storage media for execution by at least one of the one or more processors, the program instructions comprising instructions to:
receive profile information corresponding to user calendars and user preferences;
scan user calendars for a calendar entry of interest;
analyze the calendar entry of interest to identify a location or person of interest corresponding to the calendar entry;
generate a list of social network profiles corresponding to the location or person of interest corresponding to the calendar entry; and
prompt the user to select one or more social network profiles to follow from the generated list of social network profiles.

16. The computer system of claim 15, wherein the profile information corresponds to user preferences regarding what type(s) of social network profiles to suggest and what type(s) of social network profiles to ignore.

17. The computer system of claim 15, wherein the profile information corresponds to user preferences regarding when to scan the user calendars.

18. The computer system of claim 15, wherein instructions to prompt the user to select one or more social network profiles to follow from the generated list of social network profiles further comprise instructions to prompt the user to select dates to begin following and to stop following the social network profiles.

19. The computer system of claim 15, wherein instructions to receive profile information further comprise instructions to receive information corresponding to a normal usage pattern.

20. The computer system of claim 19, wherein the profile information indicates whether or not to ignore entries corresponding to the normal usage pattern.
